(19) United States
(12) Patent Application Publication
(10) Pub. No.: US 2007/0150407 A1
(43) Pub. Date: Jun. 28, 2007

(54) Order book display tool for trading financial instruments

(75) Inventor: Peter Gilboy, Chineham (GB)

Correspondence Address: SUGHRUE MION, PLLC, 2100 PENNSYLVANIA AVENUE, N.W., SUITE 800, WASHINGTON, DC, 20037, US

(73) Assignee: RoyalBlue Financial PLC, Woking (GB)

(21) Appl. No.: 11/633,592

(22) Filed: Dec. 5, 2006

Related U.S. Application Data
(60) Provisional application No. 60/742,881, filed on Dec. 7, 2005.

(51) Int. Cl. G06Q 40/00

(52) U.S. Cl. 705/37

(57) ABSTRACT

A method and a program product embodied on a computer-readable medium for efficiently and intuitively placing a trade order through an order book display having an order display component and a market order book display component are provided. The method for efficiently and intuitively placing a trade order includes dynamically displaying market information in the market order book display component, dynamically displaying order information in the order display component, placing an order by moving the order from the order display component into the market order book display component, and executing the order by releasing the order into the market order book display component.

### CROSS-REFERENCE TO RELATED APPLICATIONS

This application claims priority from U.S. provisional application No. 60/742,881, filed on Dec. 7, 2005, the entire disclosure of which is incorporated herein by reference.

### FIELD OF INVENTION

The present invention relates to electronic trading of financial or any instrument that can be traded through a market that combines buyers and sellers who place orders to buy and sell (bids and offers) at different prices for different quantities for each instrument in general, and specifically to electronic trading of equities, derivatives, swaps, bonds, warrants and currencies. In the field of electronic trading, the speed at which a trader accurately places a buy or a sell order is of utmost importance. The present invention provides a tool for electronic traders that enables them to rapidly and intuitively match and place orders of financial instruments.

### BACKGROUND OF THE INVENTION

A commodity is an undifferentiated product that can be traded with fixed quantities and prices. Derivatives are contracts that reflect the future prices of assets. Derivatives derive their value from primary assets, such as commodities, currency, stocks, and bonds. Though the current price of an asset is determined by the current market demand for and supply of the asset, the future price of an asset remains unknown. The price can increase, decrease, or remain the same depending on the market condition. Buyers and sellers often like to hedge their bets against this uncertainty about future price by making a contract for future trading at a specified price. Such contract which is a financial instrument is called a derivative.

In the past decade or so, electronic trading of commodities, securities, derivatives, equities and financial instruments in general, have been widely accepted as a common standard. With the advent of the internet, traders have embraced electronic trading as the preferred means to buy and sell items in various market exchanges throughout the world. Traders anywhere in the world equipped with their personal computers can communicate with the computers of the host market exchanges to determine the availability of items and to place and confirm orders.

Traders engaged in electronic trading typically utilize software products that provide them with various specialized graphical user interfaces to obtain market price data, execute orders and monitor status of different market conditions. The overall ease of use and quality of features available to traders depend heavily on the individual type of electronic trading application traders are running.

In electronic trading of financial instruments, the speed at which traders can competitively place an order is of utmost importance. It is absolutely critical that each trader engaged in electronic trading be able to decide instantly whether to wait or fill an order based on the information made available to them through the electronic trading application.

Even a marginal improvement in speed during such process can yield significant returns for traders engaged in electronic trading. On the other hand, a failure to competitively fill an order in a timely manner can potentially result in significant monetary losses accumulated over time. Therefore, competitive advantage in speed is of utmost priority when developing an electronic trading application which enables a trader to engage in electronic trading.

Further, traders engaged in electronic trading must be able to process and absorb numerous market information criteria made available to them while trading. Market exchange is a fast-paced, fluid environment where price, quantity, and other market criteria constantly fluctuate within a very short period of time. The better the organization and representation of information in an electronic trading application (through the use of charts such as histograms) are, the more intuitive and easier it becomes for electronic traders to trade. Therefore, in order to provide efficient and accurate placement of orders in an electronic trading environment, it is also imperative that the electronic trading application be intuitive and user-friendly for traders to use.

### SUMMARY OF THE INVENTION

The inventors of the present invention have developed an electronic trading application which enables traders to both rapidly and intuitively place, execute, modify, and manage orders. The present invention provides a method of efficiently and intuitively placing a trade order through an order book display tool which has a client or proprietary order display component and a market order book display component.

In another aspect of the present invention, a computer program product embodied on a computer-readable medium for efficiently and intuitively placing a trade order through an order book display tool which has an order display component and a market order book display component is also provided.

### BRIEF DESCRIPTION OF THE DRAWINGS

The above and other features and advantages of the present invention will become more apparent by describing in detail following exemplary embodiments thereof with reference to the attached drawings in which:

FIG. 1 shows an illustrative and exemplary embodiment of a market order book display component;

FIG. 2 shows an illustrative and exemplary embodiment of an order display component that can either be a client order or a trader's own proprietary order.

FIG. 3 shows an exemplary illustration of the order book display tool showing the relative positions of the market order book display component and the order display component on a computer screen of the trader;

FIG. 4 shows an exemplary illustration of a scenario where a trader is adding an order as a limit order to the market order book at a single price level;

FIG. 5 shows an exemplary illustration of a scenario where a trader is adding an order, and the order fully matches and executes against a single best price level shown in the market order book display component;

FIG. 6 shows an exemplary illustration of a scenario where a trader is adding an order, and the order partially matches and executes against a single best price level shown in the market order book display component;

FIG. 7 shows an exemplary illustration of a scenario where a trader is adding an order, and the order fully matches and executes against multiple best price levels shown in the market order book display component;

FIG. 8 shows an exemplary illustration of a scenario where a trader is adding an order, and the order partially matches and executes against multiple best price levels shown in the market order book display component

### DETAILED DESCRIPTION OF THE PREFERRED EMBODIMENTS

In the preferred exemplary embodiments of the present invention, the order book display tool for trading financial instruments is implemented on a computer or a fixed electronic terminal. The computer communicates with the market exchange host computer to receive various market information including prices and volumes of the different bids and offers.

An exemplary and illustrative embodiment of the order book display tool comprises two main components. The order book display tool comprises a market order book display component and an order display component.

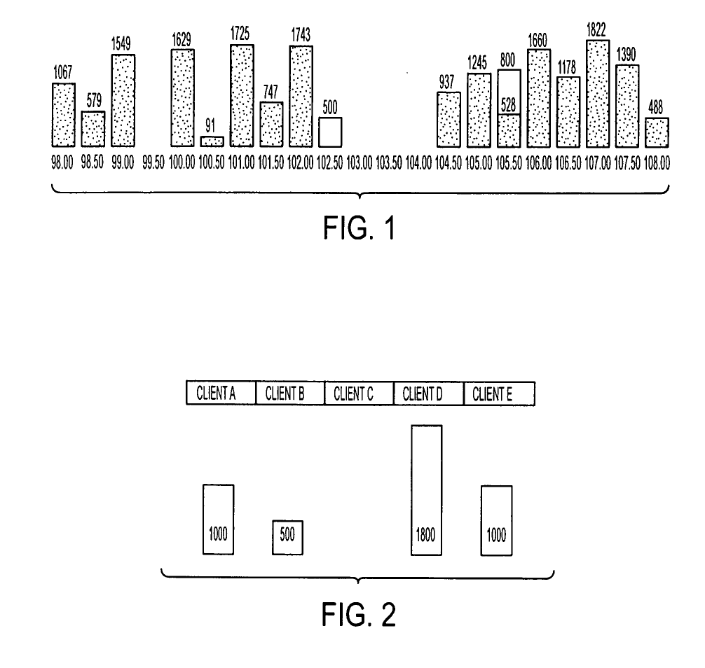

FIG. 1 shows an illustrative and exemplary embodiment of a market order book display component. The orders outstanding in the market order book display component are represented as a histogram chart. The y-axis represents volume of contracts currently outstanding in the market. The x-axis represents the price. Each individual bar, therefore, represents the volume of contracts available in the market at a particular price. Each individual bar is dynamically updated as the market condition fluctuates due to multiple traders simultaneously placing and executing orders.

As mentioned above, FIG. 1 is only an illustrative and exemplary embodiment of a market order book display component, and therefore, the histogram chart can be represented in other illustrative ways. For example, alternatively, the histogram chart can be represented with the vertical y-axis indicating the price and the horizontal x-axis indicating the volume of contracts available in the market.

Further, the y-axis representing the volume of contracts may be represented in a non-linear manner. For example, the y-axis volume can be represented in a logarithmic scale to accommodate different magnitude of volumes depending on the scale of magnitude of trade volumes in the market.

In the illustrative and preferred embodiment of the market order book display component, buy orders and sell orders are distinguishingly color-coded. For example, buy orders can be represented in blue, and sell orders can be represented in red.

In the illustrative and preferred embodiment of the market order book display component, solid bars are used to represent orders in the market from participants other than the trader-user, and outline bars are used to represent the trader-user's own orders. For example, an outline bar stacked on top of a solid bar represents that the trader-user's own orders and orders from other participants exist at the same price level. As stated previously, the market order book display component is dynamically updated to reflect the current status of the market.

FIG. 2 shows an illustrative and exemplary embodiment of an order display component. The order display component displays the volume of orders that have been placed with the broker either directly by the client or on behalf of a client. As it was the case for the market order display component, a histogram is used to intuitively represent the volume of orders for each client.

In the illustrative and preferred embodiment of the order display component, the horizontal x-axis indicates individual client identification, and the vertical y-axis indicates the volume of orders outstanding for each client. Each individual bar, therefore, represents the volume of orders for a particular client, and the order display component is dynamically updated as the volume of orders changes over time.

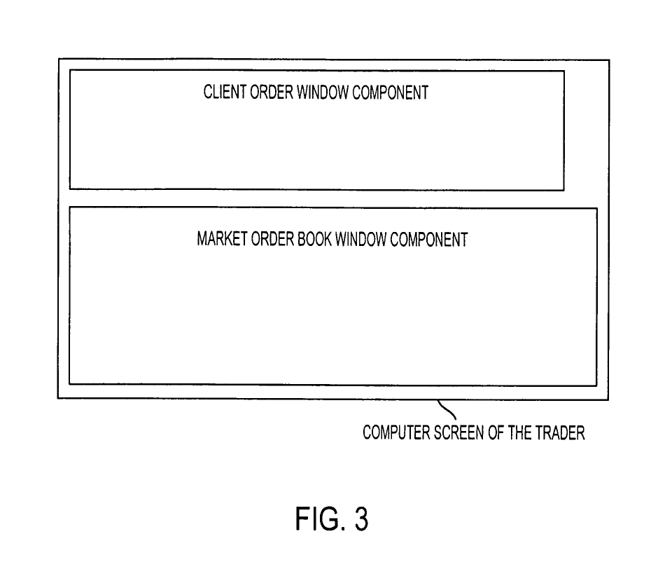

FIG. 3 shows an exemplary illustration of the order book display tool showing the relative positions of the market order book display component and the order display component on a computer screen of the trader. As a way of an example, the order display component can be placed on the top-half of the trader-user's computer screen and the market order book display component can be place on the bottom-half of the trader-user's computer screen.

Whenever the electronic trader decides to place an order in the market, the order can be placed in the market by moving it from the order display component to the market order book display component. More specifically, the placing of orders involves the following operations: 1) moving the user's mouse to the order display component and particularly to the desired orders to be placed in the market; 2) clicking the user's mouse button on the order; 3) moving the user's mouse to the desired price-level location in the market order book display component (“drag”); 4) releasing or clicking the user's mouse button to place and execute an order at the desired price-level within the market order book display component (“drop”).

The operations described above can accommodate a process known as “click and stick.” In such process, a trader can click on a desired order in the order display component with his or her mouse, and the order clicked on remains anchored to the mouse pointer (“click”). In other words, the clicked and anchored order moves with the mouse movement of the trader and is released only when the mouse button is pressed again (“stick”). Therefore, the trader placing the order utilizing such “click and stick” process does not need to continually press down on the mouse once having clicked on the order. It is to be noted that the “stick” operation is the equivalent of the aforementioned “drop” operation in that they both place the selected order in the market order book display component.

The particular price level at which the order is “dropped” indicates the limit price at which the order will be entered into the market. Prior to the “drop” operation of placing an order, there is provided a “preview” of the order being placed. When the order is placed on top of the desired price level within the market order book display component prior to the “drop” operation, the order volume bar of the particular price level is automatically reflected to preview how the bar would appear in case the placement of orders is executed.

A number of different scenarios can potentially play out while placing orders in the market using the order book display tool. Electronic markets typically support a number of execution styles for orders. For example, styles including but not limited to, “good until cancelled,” “immediate or cancel (fill or kill),” “complete volume”, “stop loss”, “profit lock”, one order cancels another (OCO) can be implemented. An aspect of the order book display tool is to afford the user-trader a range of choices regarding which execution style he or she wises to apply prior to placing orders into the market.

Both the preview displayed when an order is dragged over the market order book window, and the execution of that order once it is placed in the market will intelligently reflect both the selected execution style and the size of the order relative to the volume available in the market.

Differences particularly pertaining to three exemplary execution styles (“good until cancelled,” “immediate or cancel,” and “complete volume”) will now be described in detail. For illustrative purposes, a situation where an order for 1000 lots is placed over a market price level where only 800 lots are available is assumed.

For an execution style of “good until cancelled,” a preview display will redraw the price level bar as a hatched area equivalent to 800 lots, topped by an outline bar for the 200 lots that will remain working in the market after the order has executed. Subsequent to the market order execution, the remaining 200 lots will be displayed as an outline bar at the selected price level.

For an execution style of “immediate or cancel,” a preview display will redraw the price level bar as a hatched area equivalent to 800 lots. However, no outline bar will be shown as any remaining volume will automatically be pulled from the market after the order has executed. Therefore, subsequent to the market order execution, the unfilled order of 200 lots will be left attached to the user's mouse pointer, allowing the user to continue to trade the remainder of the order.

For an execution style of “complete volume,” a preview will leave the price level bar unchanged as the market volume is insufficient to completely fill the order. No order will be executed in the market, and the 1000 lots will be continuously attached to the user's mouse pointer, thereby allowing the user to continue to trade the entire 1000 lots.

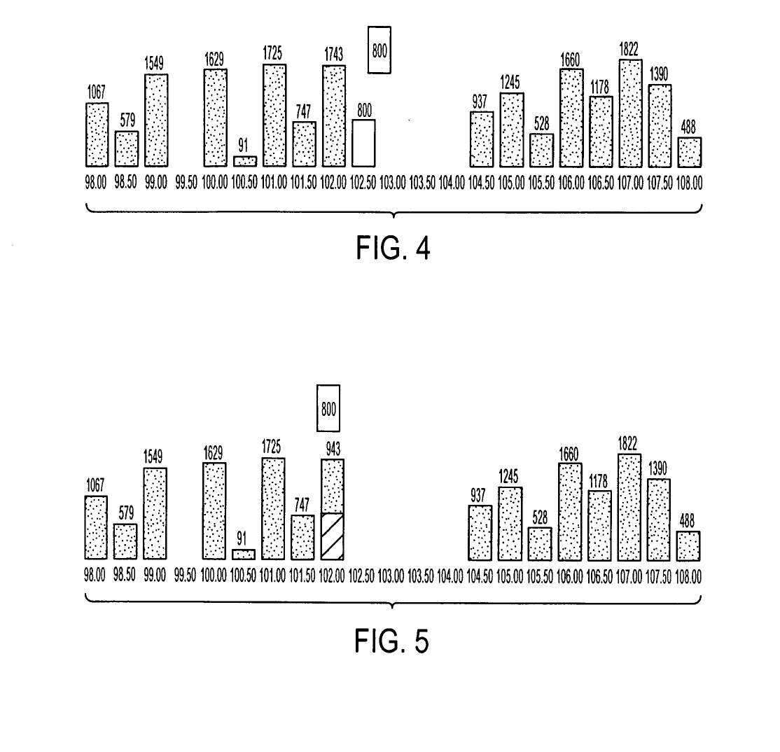

Now, following exemplary scenarios are described in detail with reference to FIGS. 4-8. It is to be noted that there can be other potential scenarios facing the trader while placing an order using the order book display tool, and that the scenarios described herein are exemplary and illustrative in nature. For illustrative purposes, an execution style of “good until cancelled” is assumed.

FIG. 4 shows an exemplary illustration of a scenario where a trader is adding an order as a limit order to the market order book at a single price level.

There is no pre-existing volume in the market at the particular price level of 102.5 at which the trader is placing an order of 800. Once the trader clicks and drags the order over to the market order book display component at the desired price level of 102.5, the order of 800 volume can be previewed in the price level of the market order book display component. Once the trader drops and thereby executes the placement of order, the order volume of 800 is summarily added as a limit order to the market order book display component at the price level of 102.5.

FIG. 5 shows an exemplary illustration of a scenario where a trader is adding an order, and the order fully matches and executes against a single best price level shown in the market order book display component.

The matching volume at the price level of 102.00 is shown as a hatched area on the matching market order. The portion of the market volume that will remain after the execution of the order (trade) is previewed as a solid bar with a numerical value within the bar representing the precise remaining market volume. As it is the case with all other scenarios, the expected price and volume of the resultant trade are previewed prior to the actual execution of orders and “drop” operation by the trader.

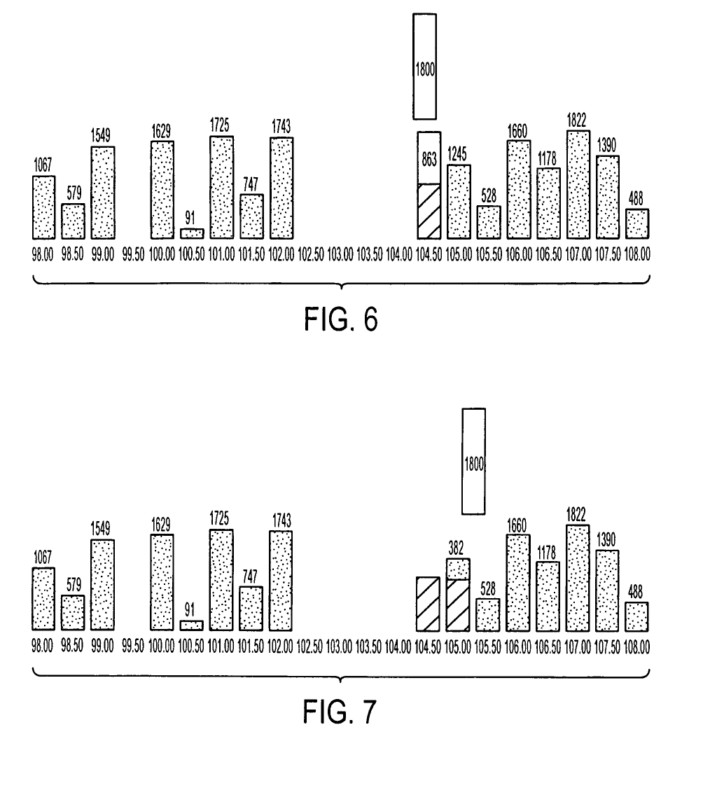

FIG. 6 shows an exemplary illustration of a scenario where a trader is adding an order, and the order partially matches and executes against a single best price level shown in the market order book display component.

As it is shown in the market order book display component, the price level of 104.5 had 937 pre-existing outstanding market orders. Therefore, if the order volume of 1800 orders are to be placed at the price level of 104.5, a volume of 863 would be left unfilled by the market. Again, the matching volume that can be met by the market is displayed as a hatched area of the bar at the price level of 104.5. The portion of the order volume unable to be filled by the market and remaining after the execution of the order is shown as an outline bar with a numerical value within the bar representing the precise unfilled order volume (e.g., 863). As it is the case with all other scenarios, the expected price and volume of the resultant trade are previewed prior to the actual execution of orders and “drop” operation by the trader.

FIG. 7 shows an exemplary illustration of a scenario where a trader is adding an order, and the order fully matches and executes against multiple best price levels shown in the market order book display component.

As it is shown in the market order book display component, the price level of 104.5 had 937 pre-existing outstanding market orders. Therefore, if the order volume of 1800 orders are to be placed at the price level of 104.5, 863 orders would still be left unfilled by the market. However, such unfilled orders may be met by market offers at a higher price level. For example, the trader may elect to fill the remaining 863 orders at a higher price level of 105.00. The trader can simply drag the order volume of 1800 to the right from the price level of 104.50 to 105.00, once the hatched area appears during the preview at the price level of 104.50. The matching volume is shown as a hatched area on the matching market order. Any portion of the pre-existing market volume remaining after the execution of the order is shown as a solid bar with a numerical value within the bar representing the precise remaining market volume. As it is the case with all other scenarios, the expected price and volume of the resultant execution of orders are previewed prior to the actual execution of orders and “drop” operation by the trader.

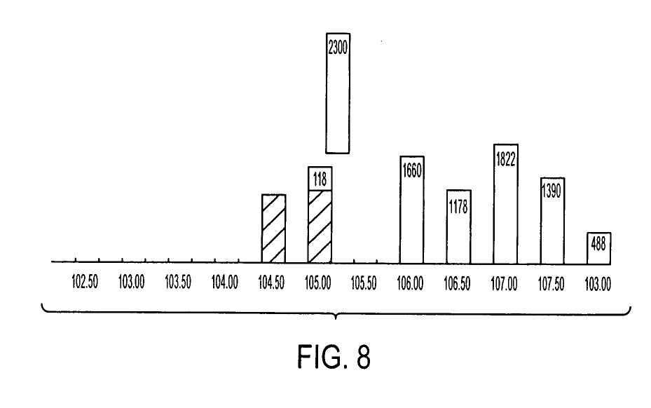

FIG. 8 shows an exemplary illustration of a scenario where a trader is adding an order, and the order partially matches and executes against multiple best price levels shown in the market order book display component.

The matching volume is shown as a hatched area on the matching market order. Any portion of the order volume unfilled and remaining after the execution of the order is shown as an outline bar. As it is the case with all other scenarios, the expected price and volume of the resultant trade are previewed prior to the actual execution of orders and “drop” operation by the trader.

In addition to all the illustrative scenarios described above, it is to be noted that once an order has been entered, but has not yet been executed, in the market order book display component, the trader may later elect to move the order to a different price level within the market order book display component. A trader may effect such change by simply clicking and dragging the previously entered order to a new price level within the market order book display component as long as the previously entered order has not yet been executed. Further, a previously entered order may be removed from the market by clicking and dragging the order to the area outside the histogram chart of the market order book display component. Prior to the execution of either of the operations, the market order book display component can be previewed to see how it would appear in case the operation is executed.

In addition, the user will be able to create a virtual market order book that combines the bids and offers of two different instruments such as a derivative contract and its corresponding asset (e.g. Microsoft stock with an Microsoft future or options contract). This type of trading is sometimes referred to as Pairs trading or synthetic strategies. When configured this way, the trader/user manipulates and executes such pairs or synthetic strategies in the same way as if they were individual orders.

While the present invention has been particularly shown and described with reference to exemplary embodiments and illustrations thereof, it will be understood by those of ordinary skill in the art that various changes in forms and details may be made therein without departing from the spirit and scope of the present invention as defined by the following claims.

What is claimed is:

1. A method of efficiently and intuitively placing a trade order through an order book display tool having an order display component and a market order book display component, the method comprising:
dynamically displaying market information items in the market order book display component;
dynamically displaying order information items in the order display component;
placing an order by moving the order information item from the order display component into the market order book display component;
executing the order by releasing the order information item into the market order book display component.

2. The method of claim 1, wherein the market order book display component and the order display component each comprises a histogram chart to dynamically display and update information.

3. The method of claim 2, wherein a horizontal x-axis of the order display component represents an identity of each of the plurality of clients placing orders and a vertical y-axis of the order display component represents volume of orders; and wherein a horizontal x-axis of the market order book display component represents a price level and a vertical y-axis of the market order book display component represents volume of market orders outstanding in the market.

4. The method of claim 3, wherein the placing of the order by moving the order information item from the order display component into the market order book display component further comprises:
moving a user computer mouse over to the order information item in the order display component;
selecting the order information item by clicking the user computer mouse button;
dragging the selected order information item into the market order book display component;
moving the selected order information item on top of a desired price level within the market order book display component.

5. The method of claim 4, wherein moving the selected order information item on top of the desired price level within the market order book display component further comprises:
previewing the market information item at the desired price level.

6. The method of claim 5, wherein executing the order by releasing the order information item into the market order book display component further comprises:
clicking the user computer mouse button to drop the selected order information item into the desired price level within the market order book display component;
updating the market information item at the desired price level.

7. The method of claim 6, wherein the previewing the market information item at the desired price level and the executing the order by releasing the order information item into the market order book display component dynamically changes according to an execution style selected by the user.

8. The method of claim 7, wherein the execution style is one of “good until cancelled”, “immediate or cancel”, “complete volume”, “stop loss”, “profit lock” and “one order cancels another”.

9. The method of claim 1, wherein the order is one of a client order and a proprietary order of a trader.

10. The method of claim 1, wherein the market order book display component utilizes a virtual market order book which combines bids and offers of a plurality of different instruments.

11. A computer program product embodied on a computer-readable medium for efficiently and intuitively placing a trade order through an order book display tool having an order display component and a market order book display component, comprising:
program instructions for dynamically displaying market information items in the market order book display component;
program instructions for dynamically displaying order information items in the order display component;
program instructions for placing an order by moving the order information item from the order display component into the market order book display component;
program instructions for executing the order by releasing the order information item into the market order book display component.

12. The program product according to claim 8, wherein the market order book display component and the order display component each comprises a histogram chart to dynamically display and update information.

13. The program product according to claim 9, wherein the horizontal x-axis of the order display component represents an identity of each of the plurality of clients placing orders and the vertical y-axis of the order display component represents volume of orders; and wherein the horizontal x-axis of the market order book display component represents the price level and the vertical y-axis of the market order book display component represents the volume of market orders outstanding in the market.

14. The program product according to claim 10, wherein the program instructions for placing the order by moving the order information item from the order display component into the market order book display component further comprises:
program instructions for moving a user computer mouse over to the order information item in the order display component;
program instructions for selecting the order information item by clicking the user computer mouse button;
program instructions for dragging the selected order information item into the market order book display component;
program instructions for moving the selected order information item on top of a desired price level within the market order book display component.

15. The program product according to claim 11, wherein the program instructions for moving the selected order information item on top of the desired price level within the market order book display component further comprises:
program instructions for previewing the market information item at the desired price level.

16. The program product according to claim 12, wherein the program instructions for executing the order by releasing the order information item into the market order book display component further comprises:
program instructions for clicking the user computer mouse button to drop the selected order information item into the desired price level within the market order book display component;
program instructions for updating the market information item at the desired price level.

17. The program product according to claim 13, wherein the program instructions for previewing the market information item at the desired price level and the program instructions for executing the order by releasing the order information item into the market order book display component dynamically changes according to an execution style selected by the user.

18. The program product according to claim 17, wherein the execution style is one of “good until cancelled”, “immediate or cancel”, “complete volume”, “stop loss”, “profit lock” and “one order cancels another”.

19. The program product according to claim 11, wherein the order is one of a client order and a proprietary order of a trader.

20. The program product according to claim 11, wherein the market order book display component utilizes a virtual market order book which combines bids and offers of a plurality of different instruments.
